(19) United States
(12) Patent Application Publication
(10) Pub. No.: US 2009/0239517 A1
(43) Pub. Date: Sep. 24, 2009

(54) MOBILE TELEPHONE HAVING CHARACTER INPUTTING FUNCTION

(76) Inventor: Tetsu Ota, Sagamihara-shi (JP)

Correspondence Address: TETSU OTA, 2-9-4 YABE, SAGAMIHARA, KANAGAWA, 229-0032, JP

(21) Appl. No.: 12/421,658

(22) Filed: Apr. 10, 2009

Related U.S. Application Data
(63) Continuation of application No. 10/488,532, filed on Feb. 28, 2005.

(30) Foreign Application Priority Data
Sep. 5, 2001 (JP) 2003-527984

(51) Int. Cl. H04M 3/00; G09G 5/00

(52) U.S. Cl. 455/418; 345/156

(57) ABSTRACT

A mobile telephone having character inputting function, having a display and a plurality of button for inputting characters is disclosed. A first pressing of one button among the plurality of button for inputting characters and a second pressing or releasing of the same one button are done for determining a character. A plurality of character is assigned to each one of the plurality of button for inputting characters. The input from each one of the plurality of button for inputting characters is determined among said plurality of character/string assigned to the same button, according to a time period between the first pressing and the next second pressing or releasing of the same button. After the first pressing, said plurality of character/string that consists of candidates for the input is newly displayed on the display, wherein a candidate character that will be inputted if the second pressing or releasing was done at that point of time is made visually distinguishable from other candidate.

### CROSS-REFERENCE TO RELATED APPLICATION

The present application is a continuation of U.S. application Ser. No. 10/488,532 filed Sep. 5, 2002 as an International application No. PCT/JP02/09027, which claims priority of a Japanese patent application Ser. No. 2003-527984 filed on Sep. 5, 2001, all of which are herein incorporated by reference.

### TECHNICAL FIELD

The present invention relates to telephones, in particular, technology for facilitating input operations in telephones requiring many inputs, such as mobile telephones.

### BACKGROUND TECHNOLOGY

Since telephones came into existence, operations of telephones were easy. There were only operations of hanging up and down the handset, and dialing operations. However, in recent years, as telephones became highly functional according to progresses in electronic technology, operations of telephones became complex, and input operations and volume of inputting have also become complex.

Particularly, in mobile telephones, functions requiring many character inputting/editing, command inputting operations (We call these merely “inputting.”), such as e-mail, schedule administrating, memo, web browsing, data transmission, have become popular.

As a popular character inputting method, there is one method that pre-assigns one “character series” to each push-buttons, and the user pushes the same push-button several times making the character displayed on “one location” of the display change among characters in belonging to the “character series”, until it becomes the desired character (We call this “continuous pressing method”). In this method, number of times to press button varies according to the inputting character and the user cannot input each character in same cycle.

Also, there is another method that inputs a character in combination of two button pressing operations (We call this “two times pressing method”). In this method, operations that the user must learn beforehand are too many. Therefore, it is difficult for users. Further, there is another method that predicts a character or a character string that is likely to be input, from character input histories, and enabling the user to select among candidates displayed in the screen. However, in this method, the selecting operation is complex. Furthermore, “command inputting” includes selecting various functions, direction instruction, etc., but those operations are complex.

When looking into a display on the telephone, frequent scrolling is necessary. One reason for this is that the display is small. The scrolling includes not only letting the screen display below the present screen in order to look into subsequent screen of the present display screen but also switching screen and progressing into subsequent screen. The scrolling is done frequently so it is annoying to do key operations for just that.

### DISCLOSURE OF THE INVENTION

The object of the present invention is to facilitate inputting operations in telephones requiring many inputting, such as mobile telephones.

The present invention has characteristics described in each of the claims. The present invention facilitates inputting operation of the user by improving method for inputting characters into telephones, and method for inputting operations.

### BRIEF DESCRIPTION OF THE DRAWINGS

FIGS. 1 and 2 are a portable mobile telephone according to the present invention.

FIG. 3 is a schematic drawing of a control system of a telephone according to the present invention.

FIGS. 4, 5, 6, 7, 8 and 9 are figures describing the present invention using the “input assisting display” of FIGS. 1 and 2.

FIGS. 10, 11, 12, and 15 are figures explaining methods for inputting into a telephone according to the present invention.

FIGS. 13 and 14 are figures of display portion of a telephone explaining methods for inputting into the telephone, according to the present invention.

FIGS. 16, 17 and 18 are figures explaining method for inputting into the telephone, according to the present invention.

FIG. 19 is a figure of push button portion of a telephone for explaining a method for inputting into telephone, according to the present invention.

FIG. 20 is a figure of push button portion of a telephone for explaining a prior art method for inputting into a telephone.

Labels in the figures represent as follows:
101 telephone
102 microphone
103 push buttons
104 disconnect button
105 execute button
106 direction instruction button
107 various functional buttons
108 motion detecting apparatus
109 display, screen
110 input assisting display
111 speaker
112 antenna
113 camera
114 handset up button
115 side pressing button
116 rotation dial
117 hinge portion
118 pointer
CLR clear button
120 touch pad
130 finger motion sensor
190 display
201 controller
202 dictionary
203 application
206 area for learning

### BEST MODE FOR IMPLEMENTING THE INVENTION

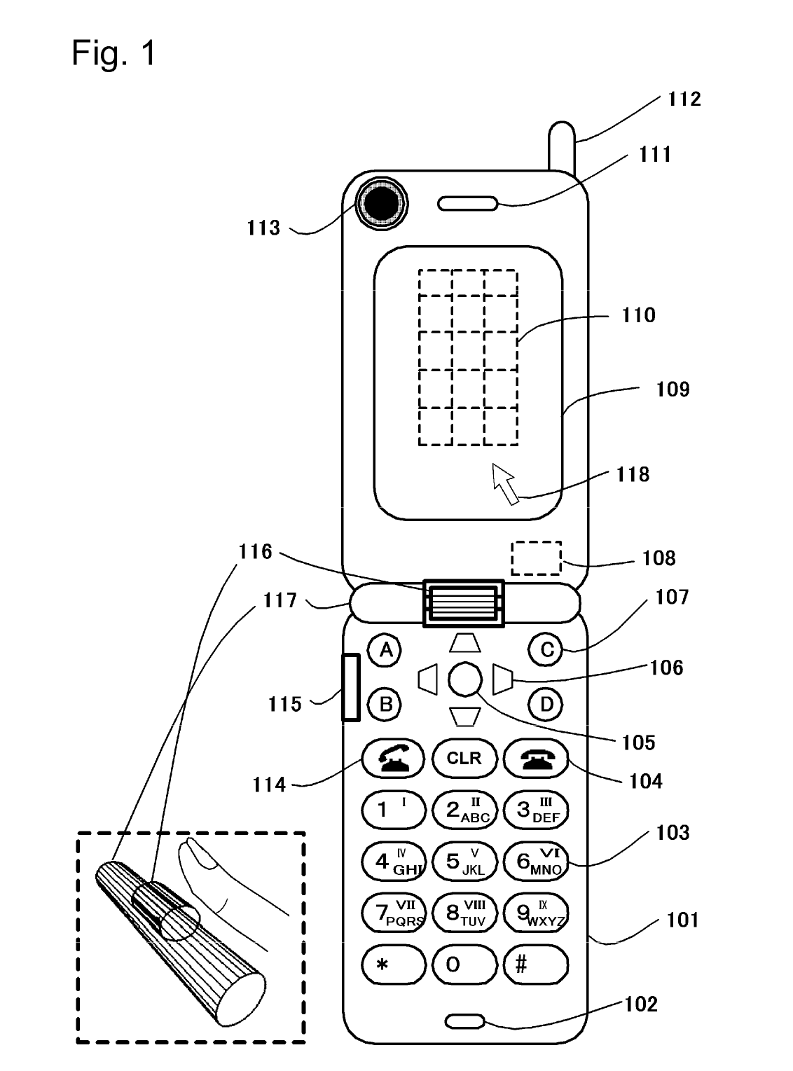

In FIG. 1, a telephone (101) according to the invention is described. A telephone (101) is a foldable portable type mobile phone that has a battery inside, and transmits and receives radio signals via an antenna (112) for voice/data telecommunications. A telephone (101) has a display (109), push buttons (103), functional buttons (disconnect button (104), handset up button (114), clear button (CLR), various functional buttons (107), execute button (105)), direction instruction buttons (106), a microphone (102), a speaker (111), an antenna (112), a camera (113), a motion detecting apparatus (108), a side pressing button (115), and a rotation dial (116).

In the push buttons (103), in addition to 1-# which represent numbers, or alike, 26 characters of alphabets which are English-type characters are assigned to eight buttons categorizing them into eight series. In addition, characters of other language (e.g., Japanese 50 phonetic characters) are categorized into nine series, the nine series are named “I series” to “IX series”, and they are each assigned to buttons 1-9 respectively.

The display (109) displays “input assisting display” (110) in addition to “general display”. Also, a pointer (118) is displayed in the display (109). The display (109) may be separately located in a plurality of portions. The “input assisting display” (110) may be displayed using a portion of screen area of the display (109) but it may be displayed in almost all the screen area of the display (109).

### Input Assisting Display (110)

“Input assisting display” (110) has an arrangement (ordering scheme) that corresponds to arrangement of push buttons (103) (and a handset up button (114), a disconnect button (104), and a clear button (CLR)). Thereby the user can easily recognize relationship between each buttons of push buttons (103) and each area of the “input assisting display” (110). Particularly, arrangement of twelve buttons of 1, 2, 3, 4, 5, 6, 7, 8, 9, *, 0, and # (We call these “12 keys”.), are the same. Expert users can do the “blind touch” (entering without seeing keys) using the 12 keys, therefore, need only to look around the display (109), and the inputting will be facilitated.

Preferably, the “input assisting display” (110) may use a different display mechanism than a display mechanism used for “general display” of display (109). Thereby, the user can easily recognize between the “general display” and the “input assisting display” (110). Preferably, the “input assisting display” (110) may be displayed using semi-translucent liquid crystal, which displays in upper level layer than the display area of the “general display” of the display (109). Thereby, the “general display” and the “input assisting display” (110) can be seen in the same place simultaneously. The size of the display (109) incorporated into the telephone is limited so the space will be efficiently used. Also, since the area the user sees becomes narrow the user need not move his/her eyeballs much so it will be more comfortable. Preferably, the semi-translucent liquid crystal display is controlled “displaying on/off” and the “displaying intensity”, by controlling light operations according to operation situations of the telephone.

In addition, optical filter mechanisms may be provided on the display (109), to be combined with the display mechanism of the display (109) so that the user can easily tell the difference between the “general display” and the “input assisting display” (110). For example, a plurality of polarization plate mechanisms may be used as the optical filter mechanism, and they may be combined with the display mechanism of the display (109) so that the user can easily tell the difference between the “general display” and the “input assisting display” (110) because of the difference in changes associated to viewing angles.

The “input assisting display” (110) comprises of cells that logically correspond to push buttons (103), functional buttons, etc., which the user can manipulate. In the case where there were a side pressing button (115), shift buttons, or a rotation dial (116), etc., cells that correspond to them may also be provided. Usually, characters or icons are displayed in the cells. The characters to be displayed may be arranged in one line or in several lines, and the character properties like font type, color, etc., may be changed according to the contents to be displayed, thereby, making users more understandable. In addition, the “input assisting display” (110) may be arranged in multi-layer in terms of displaying. It may be easily understandable if displaying layer(s) is/are categorized according to the displaying contents. For ease understanding, the “input assisting display” (110) is shown in the figure as dotted lines but the border of the cells may not be necessary. In this case, the contents of “general display” are easily seeable.

The display of the “input assisting display” (110) may be displayed only upon operation of push buttons, etc. Also, it may be intermittently or situation responding types. If so, the contents of the “general display” are easily seeable.

### Cylindrical Rotation Dial (116)

A telephone (101) is a foldable type telephone, and the hinge portion (117) connects upper side (display side) and lower side (12 keys side). The upper side and the lower side are foldable wherein the hinge portion (117) acts as an axis. The hinge portion (117) is cylindrical shape with vacancy in the center portion, and in the center portion, a cylindrical rotation dial (116) that rotates up and down around an axis is mounted. As illustrated, lateral slits are provided in the rotation dial (116) to form a gear shaped cross section so that the finger of the user does not slip. The rotation dial (116) preferably is made of a resin material that has small elasticity so that the finger of the user will not hurt. The rotation dial (116) does not rotate smoothly but rather rotates by about 10 degrees letting the user feel the click sound. Preferably, the rotation dial (116) not only rotates but also has the button function by pressing from the user's direction. This “dial pressing operation” is preferably used for the “executing” operation of a selected portion or the “click” operation during use of the pointer (118).

Rotation of the rotation dial (116) is inputted to the telephone (101) and may be used for scrolling, moving a selected portion, etc. The center of the axis of the rotation dial (116) is preferably made same as the center the axis of hinge portion (117). Comparing with a case where the two axis's are different, mounting the cylindrical member is facilitated, and also, the location relationship between the surface of the hinge portion (117) and the surface of the rotation dial (116) becomes more natural for the user so that the projection of the rotation dial (116) effectively diminishes.

In contrast, the rotation dial (116) may be shifted to the user's direction (front side) compared to hinge portion (117). In the lower left figure in FIG. 1, the location relationship of cylindrical member of the rotation dial (116) and the hinge portion (117) in this case is described. The location of axis of the cylindrical member of the rotation dial (116) and the hinge portion (117) is different. Therefore, the user can more easily manipulate with the finger, and it is advantageous when having “dial pressing” function, or in case closing the backside is needed for waterproof and preventing mis-manipulation. Regarding the outer diameter of the cylinder, the outer diameter of the rotation dial (116) is preferably smaller than the outer diameter of hinge portion (117). In this case, the movable range of the rotation dial (116) is advantageously wider.

The rotation dial (116) may be able to rotate many times in one direction. In this case, the mechanism can be simpler and can be stronger. In contrast, when pressing in one direction, the rotation dial (116) may be able to rotate only until a certain angle so that it will be back to the original starting location (home location). Then, according to the angle from the home location, the moving speed of the pointer (118), etc., is decided. In this case, it is easier to use in applications manipulating a pointer (118).

When manipulating a pointer (118), lateral direction inputting is necessary. Thus, the rotation dial (116) may be movable to move laterally, the starting position as center. When the user wants to move the pointer (118) to the left or the cursor in the screen to the left, the rotation dial (116) is pushed left by the forefinger.

### Touch Pad (120)

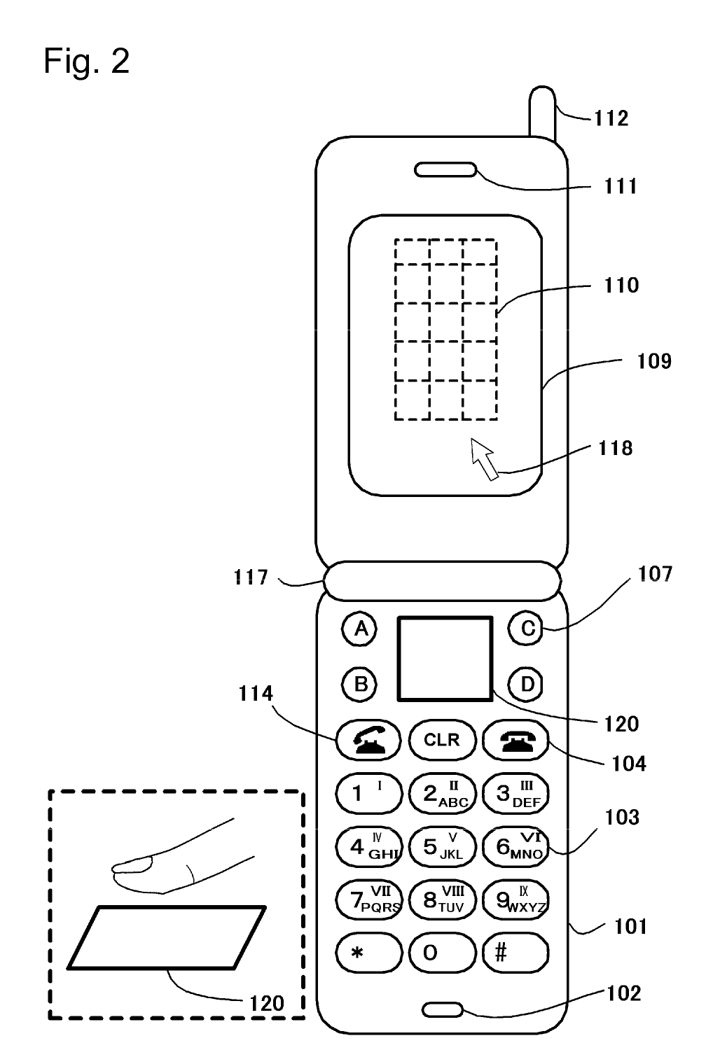

The rotation dial (116) is not good in moving in diagonal directions. As shown in FIG. 2, instead of the direction instruction button (106), the rotation dial (116) or the execute button (105), a touch pad (120) which senses pressure of a finger may be used. The touch pad (120) has similar functions to that arranged in many notebook type computers, and, as shown in lower left frame in FIG. 2, a finger is used to move a pointer (118). Not only moving the pointer (118), the touch pad (120) also does “executing” manipulation by hitting strongly by a finger, and the vertical and lateral “scrolling” manipulations by moving a finger slowly in the edge portion, and also the “drag” manipulation by moving a finger soon after a click. Also, it may be used for switching the selected portion, instead of moving the pointer (118). In the specification, “moving a pointer” includes “switching a selected portion” where a pointer is not used.

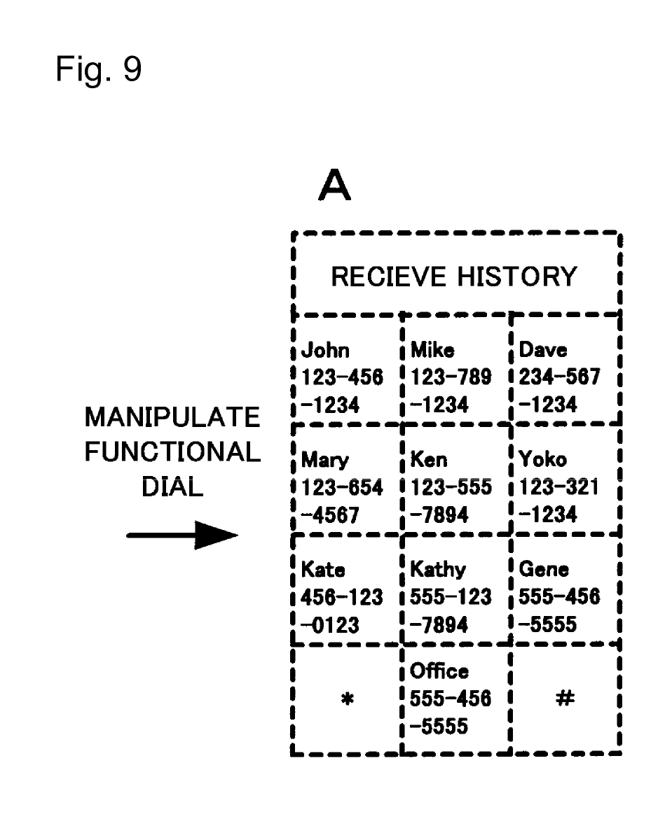

Multi-functional telephones have many buttons so it is difficult for the user to manipulate easily, and if it is equipped with a touch bad, the user interface will be dramatically improved. Currently, there are no telephones that are equipped with the touch pad (120) but telephone call handling function will be improved by having the touch pad (120). When initiating a call, the calling destination can be selected by using the touch pad (120). This is very preferable to people who do not want to select calling destinations by pressing buttons or by voice recognition mechanisms. Also, when selecting operations during the ringing status after it was called (Refer to FIG. 9.), or when manipulating the web-browser during a telephone conversation, etc., the manipulations will be dramatically improved.

Further, the touch pad (120) may be used for creating music. Many portable type telephones are capable for the user to make called-in melodies but it is done by methods that input sounds by converting sounds into numbers or special codes, and therefore, the manipulation is very difficult. By using the touch pad (120), the user can make music as if the telephone was equipped with instruments like drums or keyboard instruments by providing appropriate application software.

The touch pad (120) may also be used for drawing pictures or drawings. Many portable type telephones have functions to capture images but none has a function to create images. The reason is that drawing curves, etc., is difficult only by buttons. Preferably, the width of a drawing line changes according to the degree of pressure from the finger (it may also be the contact area of the finger).

By drawing characters as drawings and using them for character inputting, the character inputting can be done without pressing buttons. For example, drawing an alphabet “a” on the touch pad (120) by a finger can be made to be an input of the character “a”. Also, the touch pad (120) may be arranged on the surface of the display (190) to have a touch screen function. Thereby, the arrangement problem of the touch pad (120) is resolved, and also, precise manipulation is made possible by drawing in the screen traces of the finger.

The motion sensor (120) may be a touch pad that senses pressure of a finger, but if it is the case, the motion sensor (120) may be easily be out-of-order by contacting with fingers. Therefore, it may be a non-contacting type motion sensor. The motion sensor (120) instructs to a pointer (118), etc., by sensing horizontal direction motions of a finger. Also, it is preferable to sense vertical direction motions (to the motion sensor (120)) also. Thereby, not only moving the pointer (118) but also “executing” manipulation, “selecting” manipulation, “converting” manipulation of characters, etc., can be done.

### Motion Sensor Using Camera

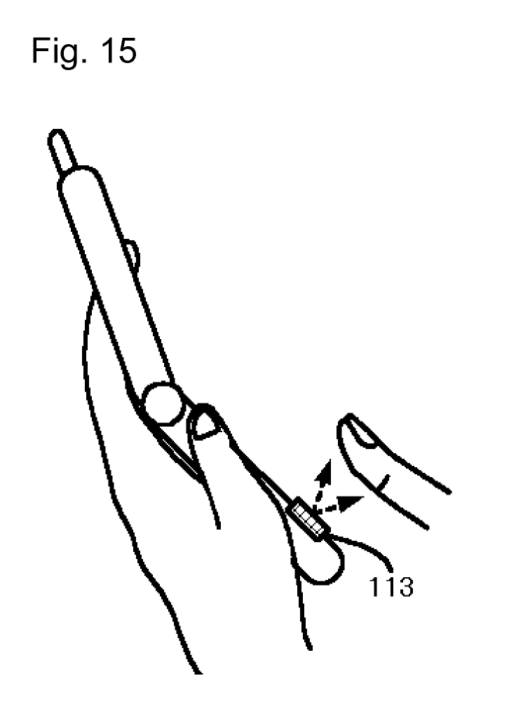

As shown in FIG. 15, the motion sensor (120) may be implemented by (inviting electric rate) sensor or radio wave sensor, but implementing by a camera (113) that senses visible light or infra-red ray in two dimensions is better because the arrangement is simple (when equipped with camera). In FIG. 15, the camera (113) is equipped in a location near push buttons (103) (near a microphone (102)). Close location is better for the finger manipulating the push buttons (103) to move.

### Arrangement of a Telephone (101)

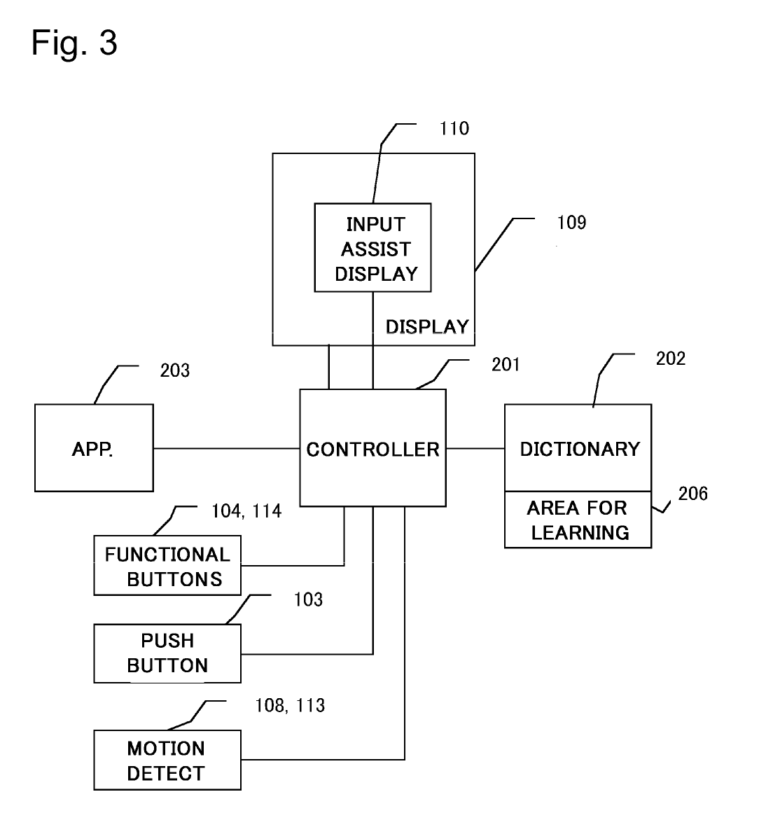

FIG. 3 describes an arrangement of the telephone (101). Controller (201) is connected to the “input assisting display” (110), the general display (109), push buttons (103), a disconnect button (104), handset up button (114), a dictionary (202), application (203), telephone call handling apparatus (208), etc., and controls them. The controller (201) may be a microprocessor, or a digital signal processor (DSP), etc., and may be provided in a plurality to distribute the functions. According to the user's manipulation, or an event from outside, the controller (201) changes display of the “input assisting display” (110) or the general display in the display (109). Upon the changing, it refers to the dictionary (202). The dictionary (202) includes area for learning (206) that holds records which correspond to the user's past manipulation or events. Usually, the area for learning (206) is a rewritable memory such as a flash memory.

### Description of the Input Assisting Display

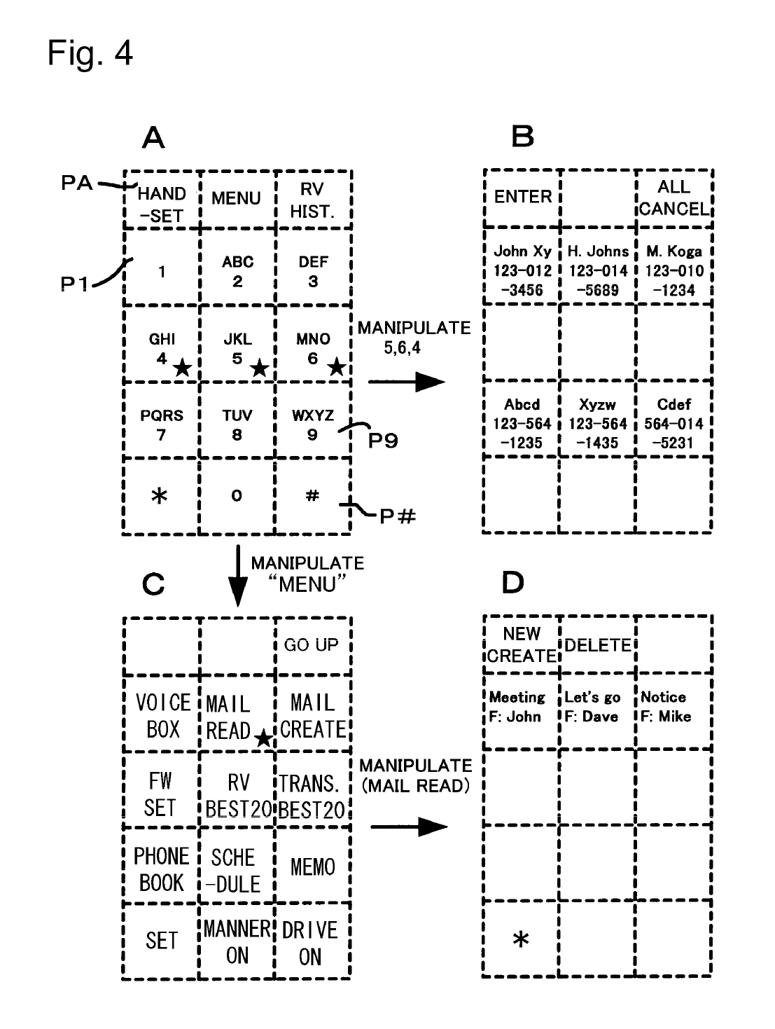

FIGS. 4-8 are figures for describing how the invention displays the “input assisting display” (110). In FIG. 4A, each cells in the “input assisting display” (110) corresponds to push buttons (103) or (a portion of) functional buttons. That is, each cell has three cell areas PA, PB and PC that corresponds to three buttons right above the push buttons (103), and twelve cell areas P1-P# that corresponds to push buttons (103) (12 keys).

FIG. 4A describes the “input assisting display” (110) that is in initial state of the telephone (101). The telephone 101 displays as shown in FIG. 4A when the power is ON, or when it is in predetermined input mode. In conventional telephones, after the push buttons (103) are pushed and a telephone number is inputted, it initiates a call by pressing button A. In the telephone (101), as each of the push buttons (103) are pushed, the display contents of the “input assisting display” (110) are changed (e.g., one change per one push). FIG. 4B describes the “input assisting display” (110) after entering 5, 6, and 4 using the push buttons (103). The star mark in FIG. 4A is shown for ease of understanding where the user manipulated. (This is the same with other drawings.) In conventional telephones, this manipulation of 5, 6, and 4 meant only the dialing manipulation of a telephone number starting with 564 but in multi-functional telephones, this may have a lot of meanings. In the latter case, it is difficult for the user to master these many meanings. The invention facilitates this, and enables to have many more meanings, that were substantially impossible with prior art. The manipulation of 5, 6 and 4 may mean a particular manipulation command or a particular character string (In this specification, “character string” includes a string includes numbers.), or a portion thereof. The invention enables to provide the “input assisting display” that presents to the user the next inputting candidates in response to input of a particular manipulation command or a particular character string, or a portion thereof.

In FIG. 4B, P9 displays name and telephone number of Mr. Cdef whose telephone number start with 564. In this phase, by pressing “9” when also pressing a press button or a shift button, etc., a call to Mr. Cdef will be initiated. In P7 and P8, Mr. Abcd and Mr. Xyzw whose telephone number includes 564 in its portion (In this case, it is included in the starting numbers of the local number.) is displayed. Thereby, the user is enabled to initiate a call by inputting only a mid-portion of a long telephone number. By continuing similar manipulations after the manipulation of 5, 6 and 4, candidates lessen. In the prior art, there are ones that display first several characters of a telephone number or a name, and narrowing the candidates as they are inputted, but the present invention provides arrangements that greatly decrease user's load by combining with the “input assisting display” (110). Also, narrowing candidates by input of only a portion of a telephone number does not narrow the candidates much, compared to narrowing candidates only by input of the first few inputs, but the presence of the “input assisting display” (110) according to the invention greatly increases the effectiveness.

Preferably, the present invention can assign meaning of character inputting to the manipulation of 5, 6 and 4, it may produce meaning of inputting characters. In this telephone (101), the characters consisting of the combination of “JKL”, “O”, and “GHI” exist as the candidates, and for example, the manipulation means “JOH” or “KOG”. Mr. John Xyzabc of P1 is displayed because his name starts with “JOH”. Mr. H. Johnson of P2 and Mr. M. Koga of P3 are displayed because their last name starts with “JOH” and “KOG”, respectively. After user doing predetermined manipulation and pushes the corresponding button, and then the call is initiated. This predetermined manipulation may be pushing the push button, shift button, etc., as described above, but it may also be double pressing (two times pushing manipulation like double clicking of a mouse), triple pressing, or irregular pressing, of the corresponding push buttons (103). In this case, it is advantageous because, for example, the user has to be interested only inside the push buttons area (103). If the user presses button A not the push buttons (103), the number “564” is used for calling, as is. If the button C is pressed, it will return to the state shown in FIG. 4A.

FIG. 4C describes a state after pushing button B (“MENU”) in the situation shown in FIG. 4A. The user can select many functions of the multi-functional telephone. Because the “general display” in addition to the display in the “input assisting display” (110) is displayed, the telephone (101) enables the user to move to a different function like schedule administrating during creation of e-mails. In this case, the e-mail creation and the schedule administrating are preferably independent of each other, and also, even if the user did not complete e-mail creation, it is advantageous if the user can return back to the same status after editing the schedule. Then, in this case, current executing function(s) may be displayed as characters or icons in the “input assisting display” (110). The transfer to another function like this embarrasses the user in the limited display information of the prior art but the present invention advantageously facilitates the transfer to another function.

In FIG. 4C, when selecting “MAIL READ (read e-mail)”, the e-mails in the mailbox currently is displayed as shown in FIG. 4D. Since FIG. 4A can display the meaning of each buttons in the push buttons (103) and the functional buttons, therefore, the user is advantageously enabled to decrease the degree of referring to the push buttons (103). In FIGS. 4B, C and D, by displaying various information in the “input assisting display” (110), that is different from the “general display”, the present invention helps acquiring the user status, and also, facilities switching of operation execution of various functions for both the developer and the user of the telephone (101).

### Method for Inputting Characters Character Strings and Sentences

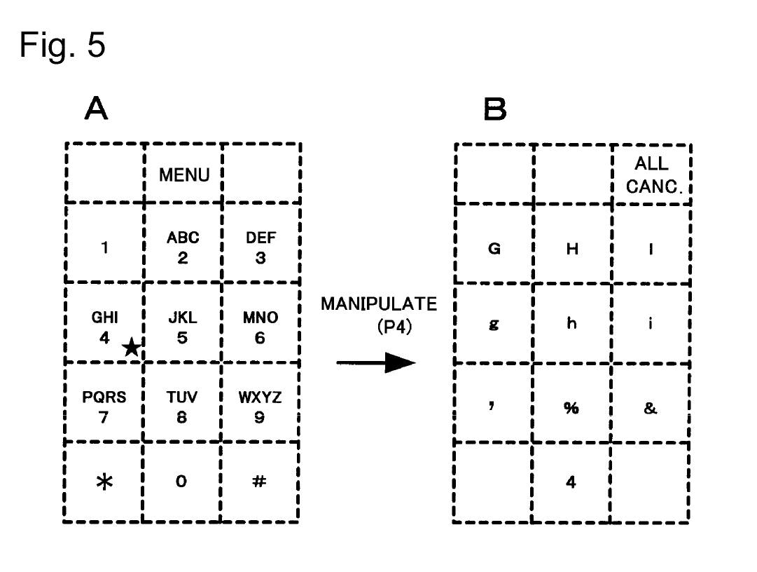

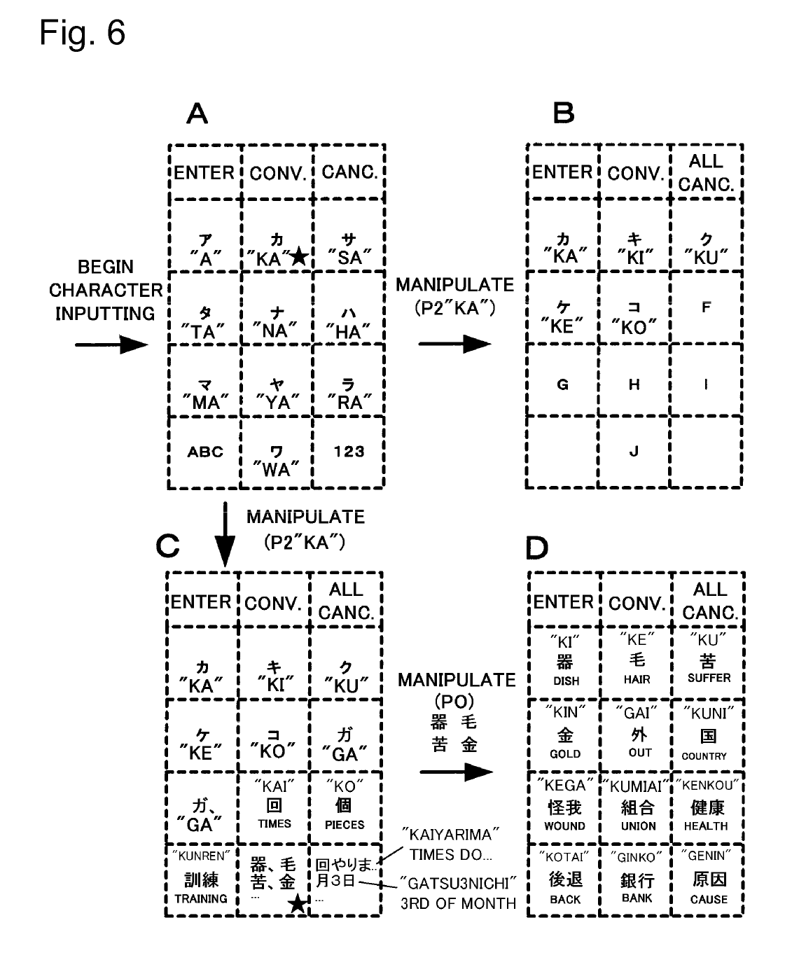

FIGS. 5-6 describe method for inputting characters, character strings, and sentences according to the invention. FIG. 5 describes method for inputting mainly English sentences. In the “input assisting display” (110), in addition to numbers, etc. (1-#), 26 characters of the alphabet are assigned to eight buttons dividing into eight series.

Let's assume that the user is in a process of creating e-mails or inputting a name in the phonebook, in the screen of the “general display”. When the user needs inputting characters, the user sees information in the “input assisting display” (110) such as shown in FIG. 5A, or in case the “input assisting display” (110) is in non-displaying status, the user sees only the screen of the “general display”, and then, when “4” is pressed, FIG. 5B is displayed as the “input assisting display” (110). Button “4” is associated with alphabets G, H and I, but in FIG. 5B, the user can choose either of G, H or I, or other characters. In the status of FIG. 5B, if the user presses one more push button (103), one character is determined to be entered. In vacant buttons in FIGS. 5A and B, in addition to symbols and numbers, control codes such as carriage-return code, or functions like “determining sentence”, or “deleting sentence” may be associated with those. Two steps character inputting is used in the example shown in FIG. 5, but it may also be three or more steps character inputting manipulation using partial button(s) among the push buttons (103).

The invention can be applied to languages other than English language, symbol series, image series, sound series, etc. FIG. 6B describes an example which applied the character inputting method of FIG. 5 to Japanese “hiragana” characters inputting. After inputting a hiragana character “KA” in FIG. 6A, it turns into FIG. 6B where the user can select hiragana characters “KA”, “KI”, “KU”, “KE”, and “KO” of the “KA” series, or other symbols, etc. Thereafter, if it is necessary, the user may push button B for converting into a different character. If “ENTER” is pressed, input of a hiragana character “KA” is determined. The display of the “input assisting display” (110) may be simplified by displaying “modes” of character inputting in a portion in the “general display”. The display of the “input assisting display” (110) is only an assisting display so it may be advantageous if it is not much noticeable.

After manipulation of a hiragana character “KA”, FIG. 6C may be displayed alternately to FIG. 6B. A hiragana character “GA” that includes a mutation modification in addition to the hiragana character “KA” is displayed in cell P6, a character string that is a portion of sentence made up relating to the hiragana character “KA” (series) is displayed in cell P7, a kanji character (Chinese character) that is another character system of the Japanese language that are constructed from one or more of hiragana characters that are fundamentals of the Japanese language, relating to hiragana character “KA”, are displayed in cells P8-P9, a combination word is displayed in cell P*, a plurality of kanji characters is displayed in cell P0, and a plurality of character strings that completes a sentence is displayed in cell P#. Preferably, displaying candidates for cells P6-P# are displayed referring to a dictionary (202) and selecting candidates that has higher possibility to be inputted.

FIG. 6D is displays after selecting the cell P0 in FIG. 6C. A plurality of kanji one character candidates and combination word candidates, relating to a hiragana character “KA” is displayed and the user can select them. Thus, the invention enables the user to select step by step, among candidates amount to hundreds and thousands, and to input characters, character strings and sentences with very small number of user input manipulations.

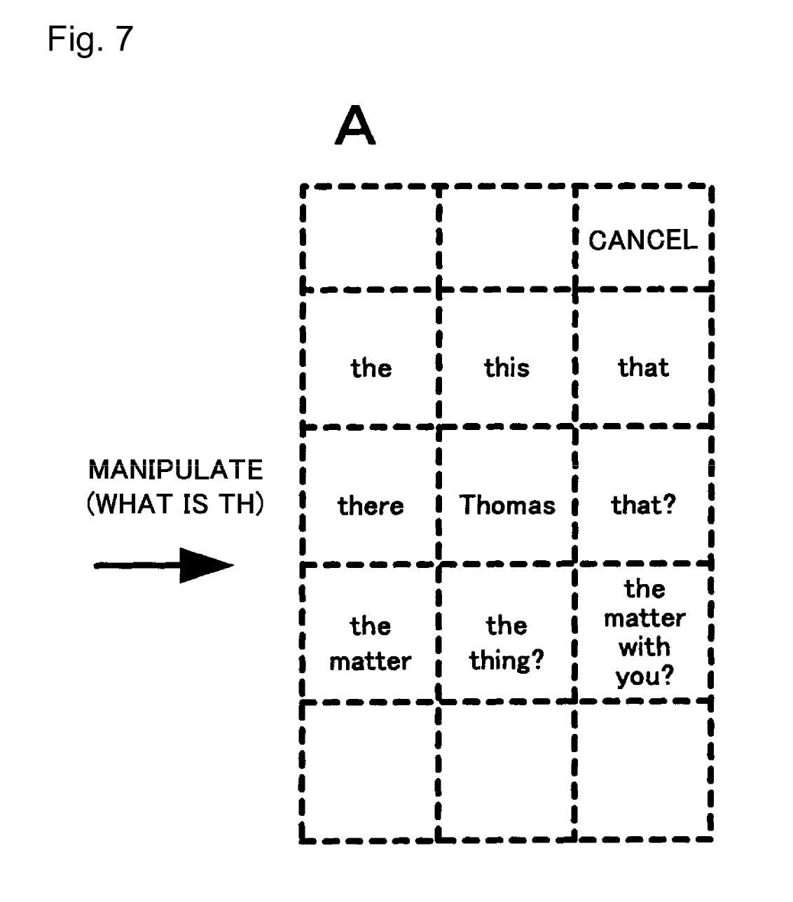

We can call methods of FIGS. 5 and 6, character context evaluated ones. Although usually more than two “button manipulations” are needed to input a character, character-context is evaluated from the first “button manipulation”, and so the second button manipulation is displayed to the user. In contract, FIG. 7 describes examples that evaluate word-context and sentence-context according to the invention. Suppose it is during the inputting of “What is th” after entering into the character inputting status. In cells P1-5, according to the word-context evaluation from the input of “th”, the five words which are the five most likely to be manipulated by the user are displayed. This is done by referring to the dictionary (202), and the past user inputs may be preferably reflected to it. In cells P6-9, according to the sententious-context evaluation from the input of “What is th”, the four “portions of a sentence” which are the four most likely to be manipulated by the user are displayed. When “What is th” is inputted as English language, it was evaluated that “that”, “the thing?”, “the matter with you?” is higher likely to be used for completing a sentence.

This invention can be effectively used for “sentence pronunciation”. In a situation such as where someone is not able to speak, the sentence he/she wants to pronounce is limited. After registering those sentences, by reducing sentence candidates in sentence groups using to the “input assisting display” (110) step by step, finally, the selected sentence is pronounced. This can also be used to input a whole composition.

By providing the “input assisting display” (110) in addition to the display of the “general display”, the user is able to do character inputting manipulation while watching the display of the “general display”. Although the inputting method according to the invention was described with the “input assisting display” (110) provided in addition to the display of the “general display”, the inputting method according to the invention improves the user inputting manipulation compared with the prior art even if it were not provided with the “input assisting display” (110) not in addition to the display of the “general display”.

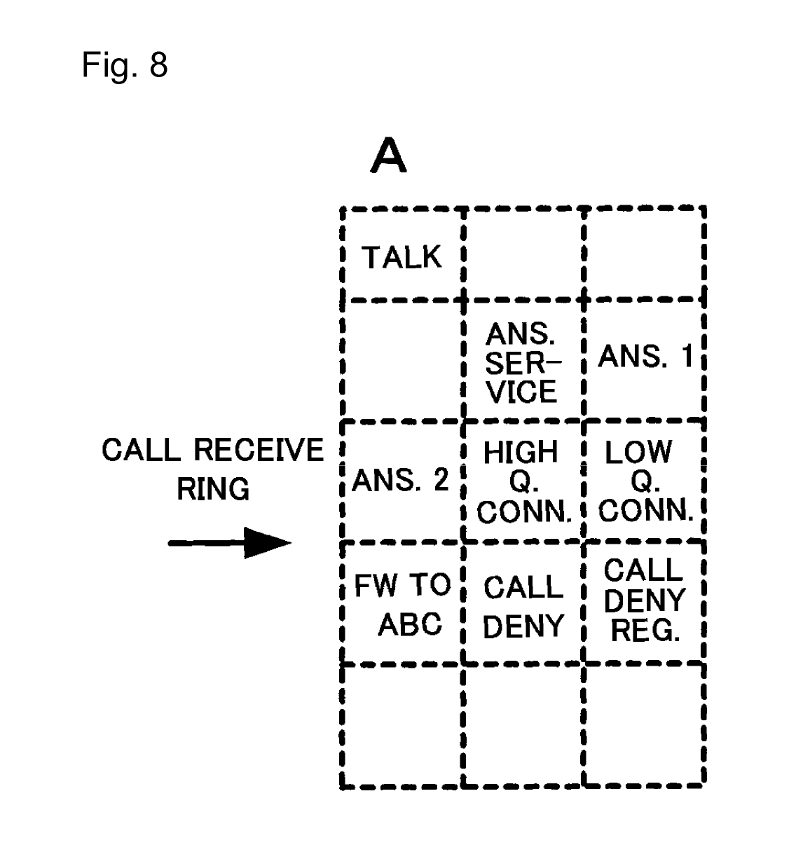

FIG. 8 describes the “input assisting display” (110) in the ring state after the telephone is called. The invention can be also used to select functions, etc., upon the ring.

In FIG. 9, the user attempts to initiate a call during manipulation of a function such as schedule administrating, and the user displayed the contents of “RECEIVE HISTORY” (or a phonebook) in the “input assisting display” (110) such as FIG. 9. The user pushes either of the push buttons (103) while pushing the function button according to the “receive history” and initiates a call. Upon the user selecting who to initiate a call (or whose information to see), the user can see the information of the “input assisting display” (110) during watching the display of the “general display” by providing the “input assisting display” (110) and “general display” independently. Also, comparing with a prior art that does not have the “input assisting display” (110) in addition to the “general display”, the display of the “general display” does not have to be changed when transferring into another manipulation (A portion of the display may be changed.), and the user does not have to watch an instant change of the screen, and thereby the user interface is improved. This advantage affects the same with other embodiments of the invention.

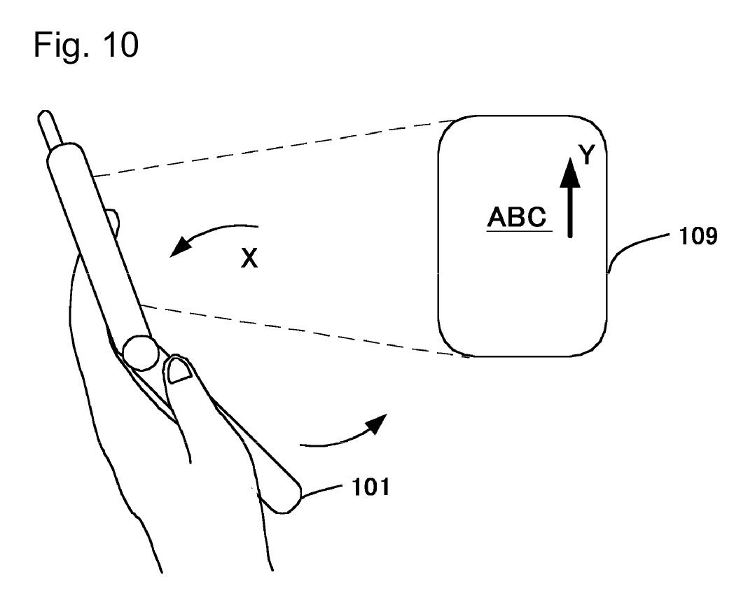

FIGS. 10-15 explain manipulation methods according to the present invention. A telephone (101) has a motion detecting apparatus (108) (including a camera (113)) (see FIG. 1). An acceleration sensor that enables three dimensions measurement by three directions correspondence is preferable for the motion detecting apparatus (108). Sensors that make use of gyro effect are also preferable. Sensors that sense spatial motion by measuring dielectric rate or responsive radio wave are also preferable.

In FIG. 10, the user has a telephone (101) in the left hand. If the user moves the telephone (101) to the “X” direction, a motion detecting apparatus (108) senses the motion, the motion is translated into “upward scroll” command, and the screen (in which the characters “ABC” are displayed) scroll upward direction (“Y” direction). This is preferably done by moving the telephone to the “X” direction a little and “moving it back”, thereby constituting one “upward scroll” command. Conversely, this may be done by issuing many “upward scroll” commands during the telephone is slanted upwards a little.

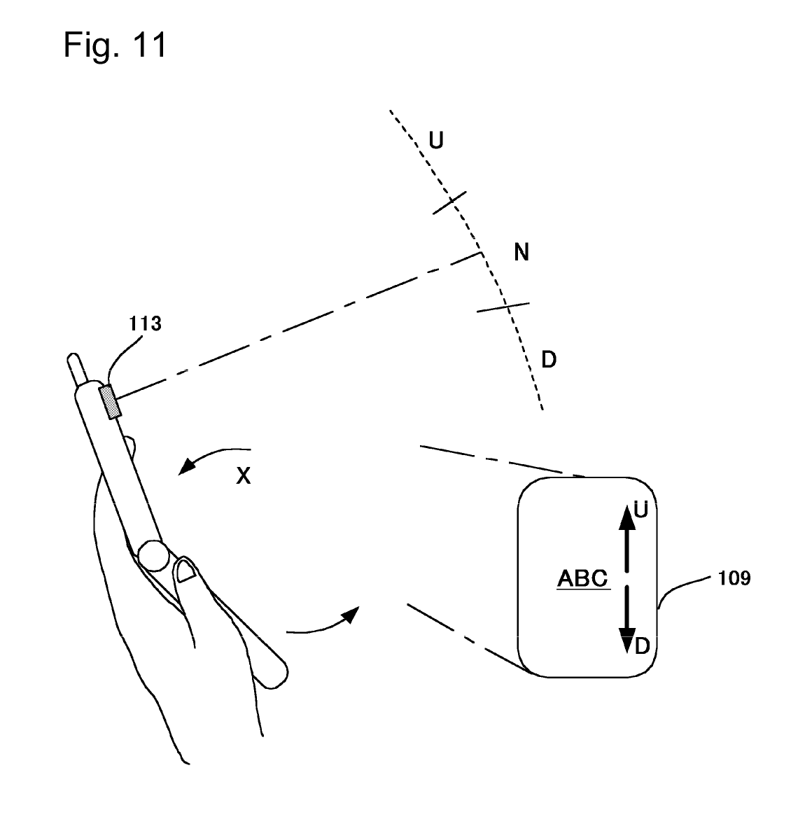

In FIG. 11, a case utilizing a camera (113) as the motion detecting apparatus (108) is described. When the user is browsing, the center of the camera is capturing the face portion of the user (“N”). The center of the camera captures the background portion (“U”) while the user is leaning a telephone (101) in the “X” direction. Then, the screen of the display (109) scrolls in the “U” direction. Conversely, if the user slants the telephone (101) in the opposite direction, the center of the camera captures the chest portion (D). And then, the screen of the display (109) scrolls in the “D” direction.

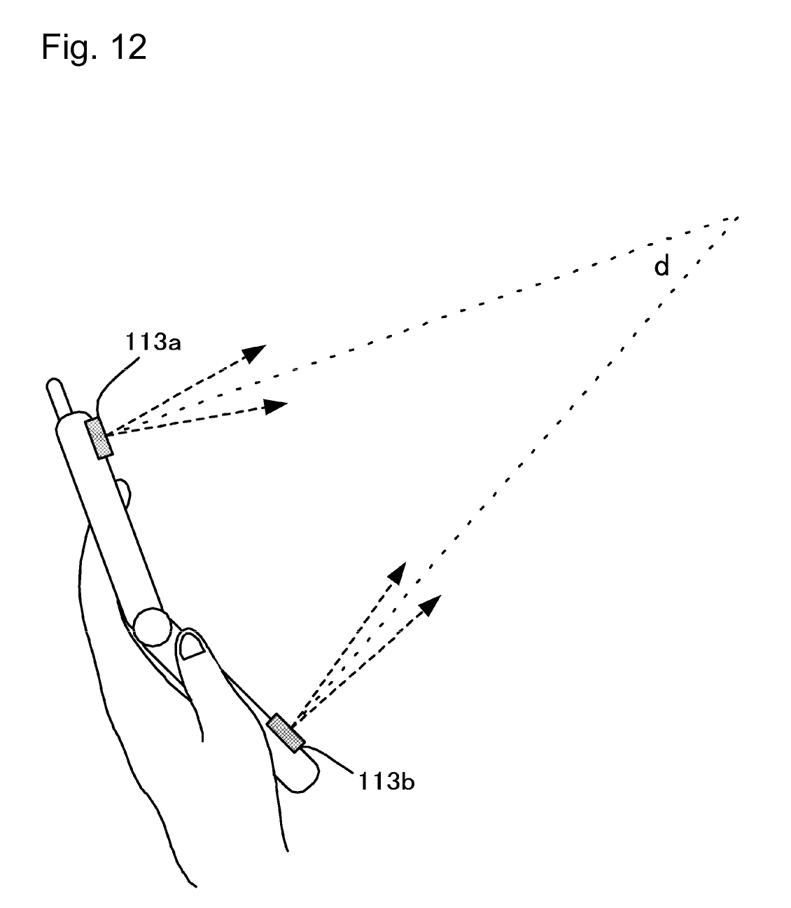

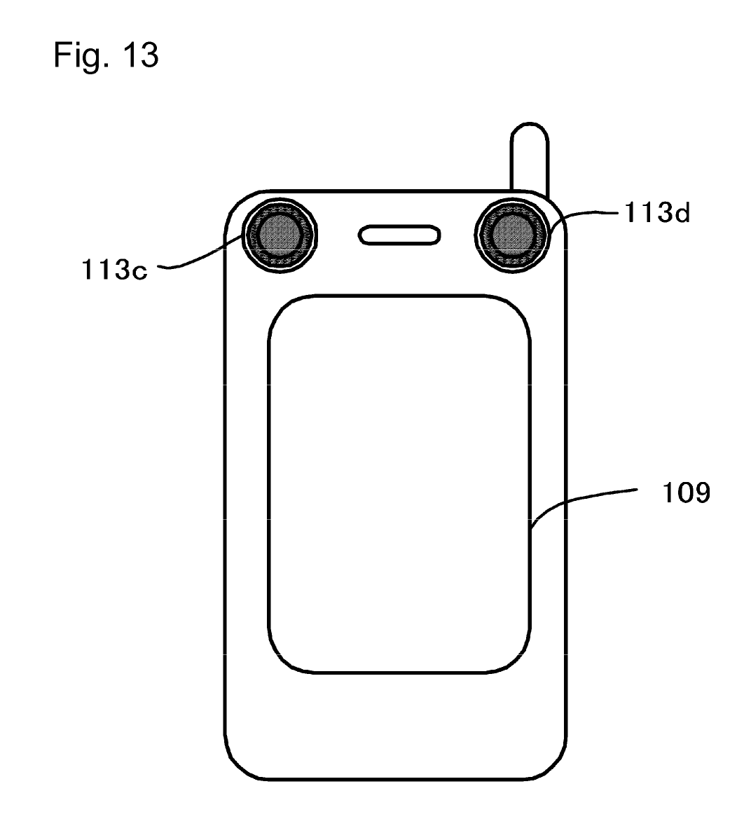

FIGS. 12 and 13 describe a case where a plurality of cameras (113) is utilized. In FIG. 11, two cameras (113a) and (113b) are equipped with a slanting angle of “d”. In FIG. 12, the two cameras (113c) and (113d) are arranged in a line laterally. In both cases, three dimensional spatial acquirement is enabled combining the two cameras. Also, keeping away the telephone (101) from the user's face may be made as an “executing” manipulation, and may also move the pointer (118) in accordance with motion of the user's finger.

Thus, implementing “three dimensional spatial acquisition”, and by utilizing “three dimension enabled display” that can display three dimensional images, for example, three dimensional 3-D spatial acquired images are enabled to display three dimensionally in the display (109), and enabled to send three dimensional images to other person so that they are advantageously displayed in the three dimensional display. The three dimension enabled display may be one that utilize polarized light effect, but one that utilize layered color appearance mechanism (liquid crystal, etc.) is preferable considering user's conveniences.

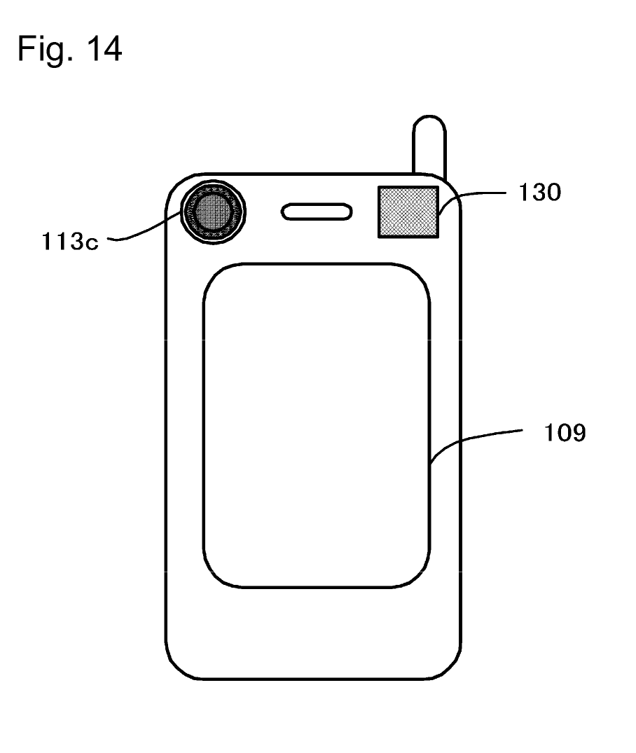

FIG. 14 describes a figure having a finger motion sensor (130) on upper portion of the telephone (101). This finger motion sensor (130) may be one that senses the motion of a finger upon sliding the finger as may be used in the touch pad (120), and may be one that senses the motion of a finger by measuring the dielectric rate or the response radio wave. In the former case, as described in FIG. 2, the proximity of the touch pad is advantageously not complicated compared with the case where the touch pad is near the push buttons (103). Also, it may equip both the touch pad located in the lower portion of the telephone and the touch pad located at a position of the finger motion sensor (130). In this case, the user is able to use a touch pad that is easier to manipulate, or may use two touch pads with different functional role. In the latter case, it may be used for correctly grasping the three dimensional space in combination with another camera (113c) (using as shown in FIG. 15).

If a finger motion sensing means, like the camera (113), is used as described in FIG. 15, the present invention enables the user to grasp the two dimensional motion, and the three dimensional motion without the finger contacting the finger motion sensing means. The finger motion sensing means (113) may be used to instruct various manipulations. The instruction of various manipulations includes “call disconnect”, “address book manipulation”, and “character inputting manipulations”. For example, in FIG. 15, the user is able to input character “a”, by drawing an alphabet “a” or its abbreviated shape in a plane horizontal to the surface of the telephone. In this case, upon the drawing, several input candidate characters are displayed and the input is advantageously done by user selecting among those input candidate characters. Thereby, it is advantageously enabled to avoid inputting errors. Also, an action moving the finger close to the finger motion sensing means (113) or an action moving the finger farther from it may advantageously be associated with certain manipulations. In case an optical camera is used as the finger motion sensing means (113) as a method for recognizing the motion moving the finger closer or the motion moving the finger farther, it is preferable to utilize the brightness being brighter and darker as the motion. Also, it is preferable to use focus adjusting mechanisms. Instead of using an optical camera for the finger motion sensing means (113), it may also utilize dielectric material, responsive radio wave, and electromagnetic inducing effect, and their combinations. It is also preferable to use a “cap”, in which material or apparatus for improving the recognition is buried, to fit in the finger.

Also, if there are any “input assisting display” in the screen (109), like the “input assisting display” (110), the present invention may advantageously assign finger motions to the meaning of “selecting manipulation” of one element in those “input assisting display”, or “a undo manipulation to return to the page immediately before.”

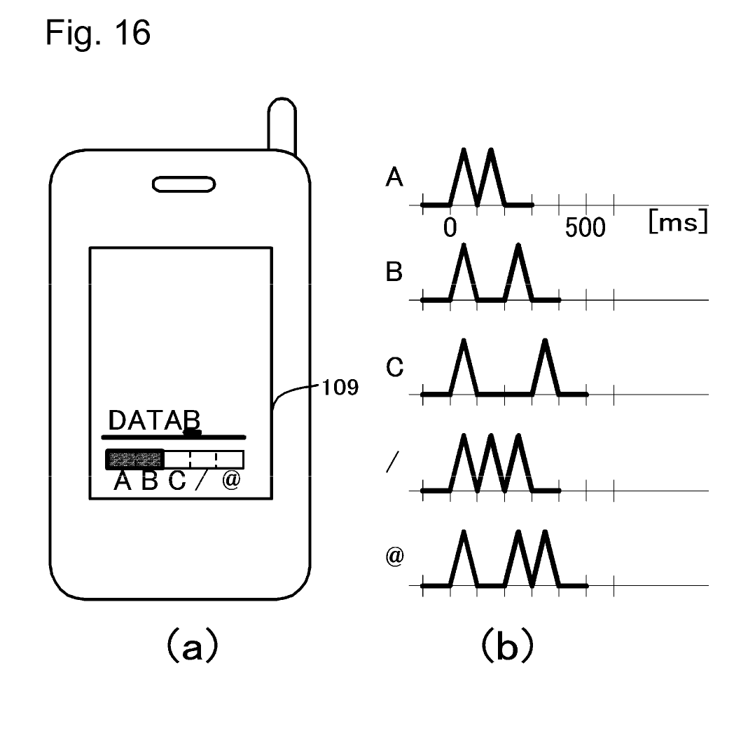

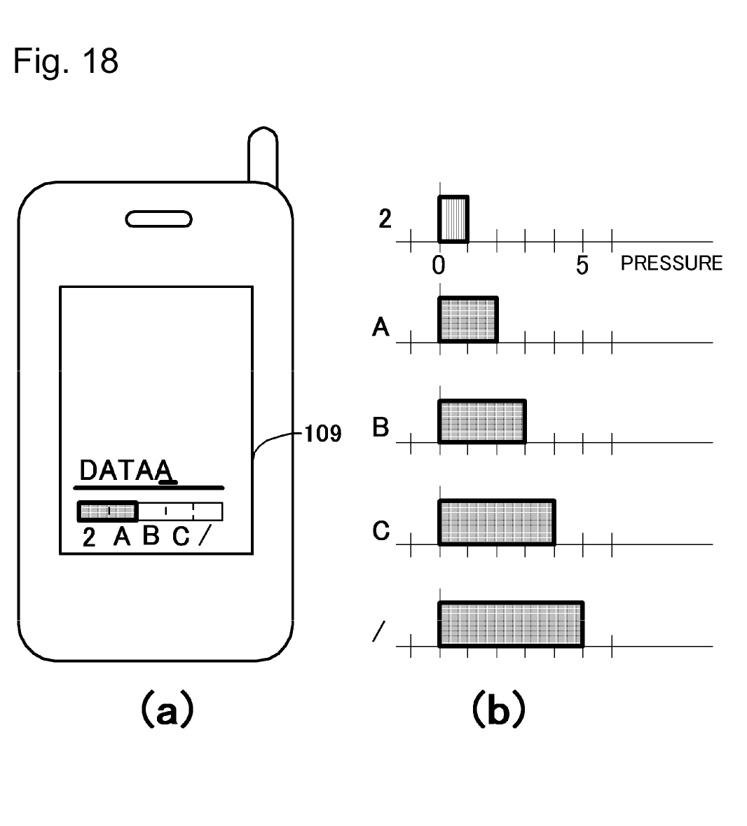

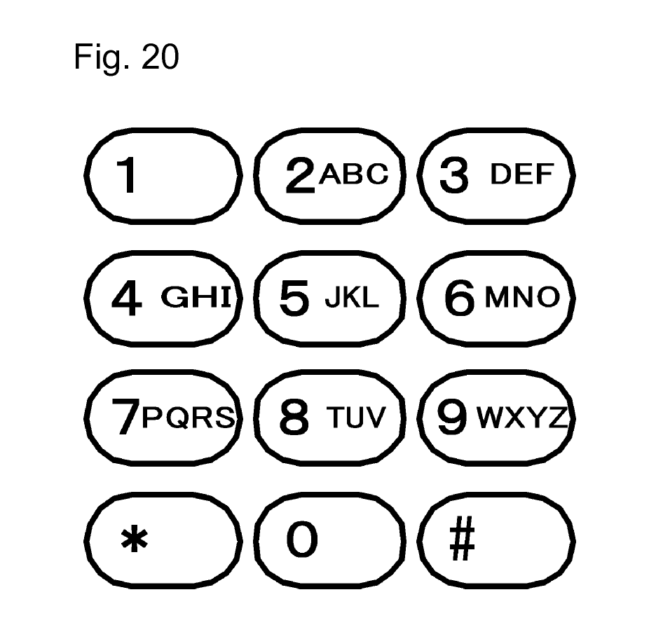

In FIG. 16, a plurality of characters are assigned to buttons for character inputting, and describes a mechanism for deciding which character to input among them, in response to time between the first pressing and the second pressing. FIG. 16 (a) is an illustration of the screen, and FIG. 16 (b) is a timing chart in which the horizontal axis indicates time by milliseconds and the vertical axis indicates button pressing depth. In the telephone of FIG. 20, a character string “DATA” is already input, and the user pressed button “2”. In the button “2”, characters “A”, “B”, “C”, “/” and “@” are assigned. In case a second pressing was done immediately after the first pressing, a character “A” will be input. Then, as the time passes, the indicator indicated in the lower portion of the screen changes itself to be longer, extending to the position for “B” and “C”, and the character indicated above the cursor (below the character “B” in the figure) changes from “A” to “B” and to “C”. Thereby, the invention enables the user to grasp the present situation visibly. Thus, in inputting characters “A”, “B” and “C”, the invention decides which character to input according to the time between the first pressing and the second pressing. Further, the invention decides which character to input from the “pressing pattern”, in inputting of “/” and “@”. Thereby, the time for determining the input of one character effectively becomes short, and shortens ending time between the inputting characters. In FIG. 16, characters “A”, “B”, “C”, “/” and “@” are assigned to one button, but instead, characters “2”, “A”, “B”, “C” and “/” may be advantageously assigned, as described in FIG. 18. In this case, the present invention effectively enables the user to input a number and alphabets without changing the inputting modes associated to numbers and alphabets.

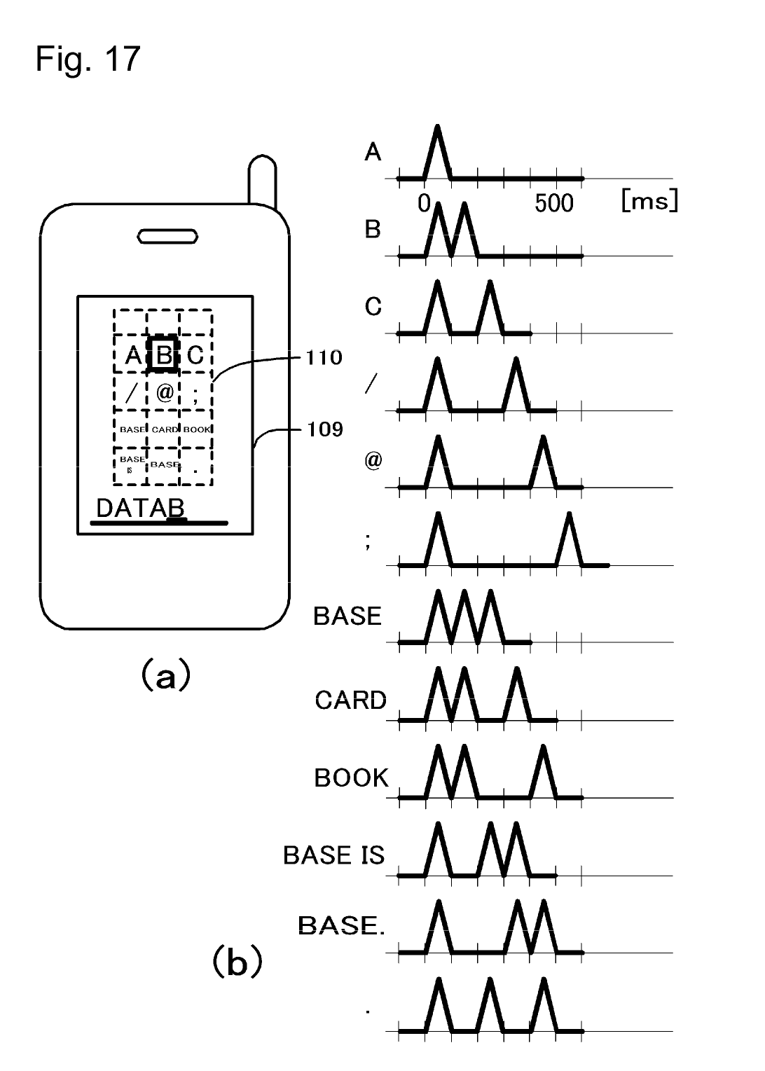

FIG. 17 describes a figure in which the inputting candidates are increased, using the “input assisting display” (110). In this case, inputting of character “A” is advantageously enabled to be completed pressing the button “only once”.

In FIG. 18, the push buttons are enabled to sense pressing pressure gradually, and describes a scheme for deciding which character to input, according to pressing pressure during user's pressing manipulation. The pressing manipulation is effectively completed by only one pressing. The “pressing pressure” may be determined by measuring the pressing depth of the button, but the measurement of the pressing depth may be combined with other mechanisms such as determining the degree of “contacting area” of the finger to the button, or “gradual” pressing button (ex. 115). By combining with other mechanism, the structure of buttons is advantageously made simple. Then, in a case using gradual pressing buttons, the pressing status of the gradual pressing button is advantageously determined, including the status not pressing anything.

It is advantageously assumed that the longer the time from the pressing until the release, the higher the pressing pressure, and thereby the pressing pressure is advantageously determined according to the pressing duration time. This case will be explained referring to FIG. 18. If the user presses button “2” (“P2”), candidate characters “2”, “A”, “B”, “C” and “/”, and an indicator indicating the character “2” will be displayed in the screen (109), and after 500 milliseconds from it, the indicator changes itself to be long to indicate the next character “A” (Situation in the screen (109) of FIG. 18). If a further 500 milliseconds elapse, the indicator changes itself to indicate “B”. If the button pressing is released in this point of time, then it is determined to be character inputting of the character “B”. If the button is not released in this point of time, then the indicator will indicate “C” next, and subsequently, “/” but after more time has elapsed, the indicator changes itself to be short to indicate the initial character “2”. Due to the stretching and shrinking of the indicator, the user is advantageously enabled to grasp current status easier. In FIGS. 16 and 18, the indicator is arranged in upper side compared with the candidate characters but the candidate characters and the indicator may advantageously be overlapped.

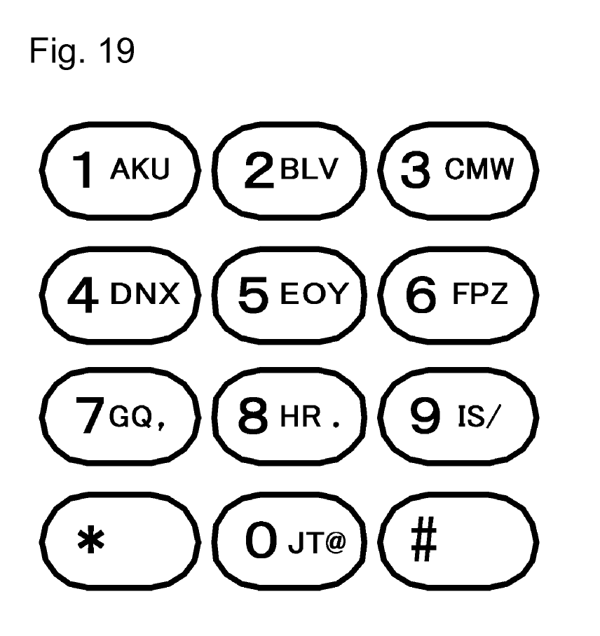

In FIG. 19, the input of one character is done combining two button pressings, namely, the first pressing and the second pressing, and a plurality of characters is indicated in the “character assignment indication” associated to each buttons. The location arrangement relationship among the plurality of characters for a button corresponds to the location arrangement of the button to press upon the first pressing (or alternatively, the second pressing). Thereafter, to input characters indicated in the buttons, it is done by pressing the indicated button as the second pressing after the first pressing. FIG. 19 describes an arrangement of the push buttons 103. For example, “1” (or other buttons in the first column) and “1” manipulation will be done for input of a character “A”, and “1” and “2” for a character “K”, and “1” and “3” for a character “U”, and “4” (or other buttons in the first column) and “6” for a character “F”, and “5” (or other buttons in the second column) and “6” for a character “P”.

Comparing the character arrangement of this scheme with the prior art, FIG. 20, characters are not successively assigned to each buttons according to the “order” of the characters (alphabets). Rather, characters are serially assigned from the first button (“1”) to the last button (“0”) and turning back to the first button after the last button. And the “character assignment indication” is printed in the right side of the numbers and in accordance with the invention, their location information for a button corresponds to the first pressing button location information. For just a first glance, scheme in FIG. 20 may have the impression of easier to grasp but because the user has to input many characters continuously among many characters, therefore, the scheme of FIG. 19 according to the invention is easier to input characters. The first pressing button corresponds to the location of the “character assignment indication” for a button, and the second pressing button is the button which the input desired character is indicated in the “character assignment indication”.

The present invention has a lot of advantages not specifically mentioned. However, a person skilled in the art is able to recognize a lot of advantages other than those described in this specification.

### INDUSTRIAL APPLICABILITY

As is clear with the above explanation, the present invention enables to provide a telephone that facilitates user manipulation.

What is claimed is:

1. A mobile telephone having character inputting function, having a display and a plurality of button for inputting characters, characterized by:
the mobile telephone is capable of inputting characters/strings of characters using the plurality of button for inputting characters,
the mobile telephone is a portable mobile telephone having a telephone function, the plurality of button for inputting characters is capable for inputting telephone numbers,
a first pressing of one button among the plurality of button for inputting characters and a second pressing or releasing of the same one button are done for determining a character/string,
a plurality of character/string is assigned to each one of the plurality of button for inputting characters,
the input from each one of the plurality of button for inputting characters is determined among said plurality of character/string assigned to the same button, according to a time period between the first pressing and the next second pressing or releasing of the same button, and
after the first pressing, said plurality of character/string that consists of candidates for the input is newly displayed on the display, wherein a candidate character that will be inputted if the second pressing or releasing was done at that point of time is made visually distinguishable from other candidate.

2. The mobile telephone according to claim 1, wherein
after said pressing of the button, all of the candidates are displayed on the display.

3. The mobile telephone according to claim 1, wherein said candidate that will be inputted if the second pressing was done at that point of time is made visually distinguishable from other candidates by expanding and shrinking an indicator which appears on the mobile telephone.

4. The mobile telephone according to claim 1, wherein said displaying of said plurality of character/string is done in an arrangement in the display that corresponds to arrangement of the corresponding buttons.

5. The mobile telephone according to claim 1, wherein said plurality of character/string consists of both characters and strings of characters.

6. The mobile telephone according to claim 1, wherein said plurality of character/string consists of characters and does not include strings of characters.

7. The mobile telephone according to claim 1, wherein said plurality of candidate is selected based on character-context evaluation.

8. The mobile telephone according to claim 1, wherein said plurality of candidate is selected based on word-context evaluation.

9. The mobile telephone according to claim 1, wherein said plurality of candidate is selected based on sentence-context evaluation.

10. The mobile telephone according to claim 1, wherein said a second pressing or releasing is done by pressing the button.

11. The mobile telephone according to claim 1, wherein said a second pressing or releasing is done by releasing the button.

12. A mobile telephone having character inputting function, having a display and a plurality of button, characterized by:
the mobile telephone is capable of inputting characters/strings of characters using the plurality of button,
the mobile telephone is a portable mobile telephone having a telephone function, the plurality of button for inputting characters is capable for inputting telephone numbers,
a pressing and a releasing of same one button are done for inputting a character/string,
each of the plurality of button for inputting characters includes pressing pressure sensing mechanism enabled to sense pressing pressure gradually in a plurality of level other than a level not pressed,
a plurality of character/string is assigned to each one of the plurality of button for inputting characters,
the input from said buttons for inputting characters is determined among the plurality of candidate including said plurality of character/string, according to the pressing pressure during user's pressing manipulation, and
after user's pressing manipulation, upon the determination, said plurality of character/string are simultaneously displayed in the display in an arrangement order corresponding to the order the characters/strings are input in response to said pressing pressure corresponding to said one button, wherein a candidate character/string that will be inputted if the pressing was discontinued at that point of time is made visually distinguishable from other candidate.

13. The mobile telephone according to claim 12, wherein said displaying of said plurality of character/string is done in an arrangement in the display that corresponds to arrangement of the corresponding buttons.

14. The mobile telephone according to claim 12, wherein said plurality of character/string consists of both characters and strings of characters.

15. The mobile telephone according to claim 12, wherein said plurality of character/string consists of characters and does not include strings of characters.

16. The mobile telephone according to claim 12, wherein said plurality of candidate is selected based on word-context evaluation.

17. A mobile telephone having character inputting function, having a display and a plurality of button, characterized by:
the mobile telephone is a portable mobile telephone having a telephone function,
the mobile telephone includes a motion detector for capturing two dimensional motion of user's finger,
said motion detector has capability of capturing user's motion drawing a character with the user's finger, and
determining an input character is done by running following steps (a)-(f) in this order:
(a) determining user's motion drawing a character with the user's finger, using said motion detector;
(b) displaying a first input assisting display, in said display, that consists of cells, the cells include a first group of selection candidates;
(c) in response to the user's selection of one of said cells in said first input assisting display, determining the selected selection candidate among said first group of selection candidates;
(d) determining a second group of selection candidates from the selected cell by looking up a dictionary stored in the mobile telephone;
(e) displaying a second input assisting display, in said display, that consists of cells, the cells include said second group of selection candidates; and
(f) in response to the user's selection of one of said cells in said second input assisting display, determining the selected selection candidate among said second group of selection candidates.
